(19) United States
(12) Patent Application Publication
(10) Pub. No.: US 2010/0276257 A1
(43) Pub. Date: Nov. 4, 2010

(54) CONVEYOR BELT, AND POWER SUPPLY LINE, DEFLECTION ROLL, PNEUMATIC DEVICE, ELECTRONIC DEVICE, CONVEYOR BELT, AND WORKPIECE RECEPTACLE THEREFOR

(76) Inventor: Eckhard Polman, Sonsbeck (DE)

Correspondence Address: RANKIN, HILL & CLARK LLP, 23755 LORAIN ROAD, SUITE 200, NORTH OLMSTED, OH, 44070, US

(21) Appl. No.: 12/594,544

(22) PCT Filed: Mar. 3, 2008
(86) PCT No.: PCT/EP2008/001673

§ 371 Date: Jun. 17, 2010

(30) Foreign Application Priority Data
Mar. 1, 2007 (DE) 20 2007 003 178.5

(51) Int. Cl. B65G 15/58; B65G 23/04

(52) U.S. Cl. 198/803.5; 198/793; 198/866; 198/835

(57) ABSTRACT

A belt conveyor comprising a continuous conveyor belt running between deflection rolls, to which a workpiece receptacle is attached. A synchronously revolving continuous power supply line is provided for the belt conveyor. The power supply line is formed separately from the conveyor belt.

This application claims priority to and the benefit of the filing date of International Application No. PCT/EP2008/001673, filed 3 Mar. 2008, which application claims priority to and the benefit of the filing date of German Application No. 20 2007 003 178.5, filed 1 Mar. 2007, both of which are hereby incorporated by reference into the specification of this application.

### FIELD OF THE INVENTION

The invention relates to a belt conveyor as well as a power supply line and a deflection roll therefor.

### BACKGROUND OF THE INVENTION

Belt conveyors are known, for example, from DE 103 15 627 A1, DE 10 2005 007 472 A1 and DE 1005 007 472 A1. In this case, a continuous conveyor belt runs between two deflecting rollers. Workpiece receptacles are provided on the conveyor belt, which locally produce a vacuum for holding the workpieces, particularly against the force of gravity, by means of, for example, Venturi nozzles. The compressed air is supplied to the workpiece receptacles by means of a continuous channel integrated in the conveyor belt. The compressed air supply of the channel is effected by means of radial forces in the deflecting rollers which discharge on the outer circumference of the respective deflecting roller and can be made to coincide with supply openings of the channel which discharge on the inner side of the conveyor belt. The radial channels are in turn connected to a compressed air source via respectively one axial channel in the axis of rotation of the respective deflecting roller.

The conveyor belt, which is mechanically weakened by the channels and channel passages, must also be configured to be mechanically stable for heavy workpieces such as automobile windows. In addition, the channels must withstand high pressures during continuous operation. The manufacture of the conveyor belt with integrated channels is therefore complex and expensive. Since it must be regularly renewed due to the severe mechanical loading by the workpieces, it constitutes an appreciable cost factor.

In addition, the workpiece receptacles of the known belt conveyor are not optimal with regard to longevity, economical operation and cost-effective manufacturability. Thus, mechanical lifting devices are required in the workpiece receptacles in order to press a suction lip against the workpiece for receiving a workpiece. Such lifting devices are expensive, require maintenance and consume energy.

In addition, in the known belt conveyors, vacuum is continuously lost at the workpiece receptacles which are not holding a workpiece and this must be generated at some expense.

### SUMMARY OF THE INVENTION

It is therefore the object of the invention to provide a belt conveyor as well as a power supply line and a deflection roll therefor which allows simplified construction with reduced maintenance and operating costs and cost-effective manufacture.

This object is achieved according to the features of the claims.

Accordingly, a belt conveyor, in particular a vacuum belt conveyor, is provided which creates a power supply line with energy-transmitting line elements separate from the conveyor belt and pneumatic and electronic devices fastened thereon as well as workpiece receptacles free from lifting devices, fastened to the conveyor belt.

The separation between the continuous conveyor belt which is mechanically loaded by the workpiece transport and the continuous power supply line running synchronously with the conveyor belt results in a significant cost reduction. Thus, when changing the conveyor belt, the expensive electronic and optionally pneumatic components including the line elements need not also be changed since they have a considerably longer lifetime. Also, it is more cost-effective to produce the conveyor belt without integrated channels.

The power supply line can transport electrical and/or pneumatic energy. To this end, it contains electrically conducting line elements such as, for example, a steel cable, or line elements which can hold compressed air, vacuum or liquids/fluids. The line elements are preferably designed separately from one another but can also be cross-linked to one another.

The line elements are expediently continuous. However, they can also be finite in order to connect sections of the power supply line to one another, e.g. between an electronic device which can contain a control circuit and a pneumatic device which has a controllable valve.

The conveyor belt and the line elements can be disposed adjacently to one another or in a space-saving manner above one another.

In this case, the workpiece receptacles remain on the conveyor belt. They are coupled to the power supply line via cables or the like. A pneumatic device is expediently assigned to a workpiece receptacle so that when activated, it supplies the workpiece receptacle with compressed air, vacuum or liquid in a controlled manner. It can also be provided that a pneumatic device simultaneously supplies a plurality of workpieces.

The belt conveyor can thus be produced and operated more cost-effectively overall and with lower maintenance.

The workpiece receptacles can contain a Venturi nozzle in order to locally produce a vacuum. Instead of this or additionally they can contain a mechanical or magnetic holding device such as a gripper or an electromagnet in order to grip and hold the workpiece. In this case, the pneumatic devices can be dispensed with and the electronic devices can be connected to the workpiece receptacles by means of cables in order to drive these and supply them with energy.

Furthermore, the workpiece receptacles no longer require lifting devices. Instead of these, the deflection in the direction of the workpiece is effected by a deflecting device.

This can be a local thickening of the conveyor belt on the side facing away from the workpiece receptacle and facing the deflection rolls. The thickening can be formed instead of a tooth if the conveyor belt is a toothed belt. The thickening can also be a fastening plate by which means the workpiece receptacle is screwed to the conveyor belt. Thus, the fastening of the workpiece receptacle can simultaneously function as a deflecting device.

The deflecting device can be deflected in a controlled manner and/or have a cam which can be deflected in a fixed or controlled manner. Also an additional deflection roll can be deflected. The deflection can be effected by means of an electrical or pneumatic drive. This results in a simple, cost-effective and low-maintenance design.

In addition, a controllable valve, in particular a pneumatic or electromechanical valve, can preferably be provided on each pneumatic workpiece receptacle by which means the vacuum can be maintained during transport of the workpiece and/or if no workpiece is being transported, without further consumption of compressed air or vacuum. This results in a considerably reduced compressed air consumption which leads to appreciable savings with regard to the costs caused by the production of compressed air.

### DESCRIPTION OF THE FIGURES

FIGS. 1 to 5 each illustrate a belt conveyor.

FIG. 6 illustrates a transport system with two belt conveyors.

FIG. 7 illustrates the conveyor belt and the power supply line of a belt conveyor.

FIG. 7b illustrates one embodiment with a power supply line feeding two conveyor belts.

FIG. 8 illustrates the power supply line from FIG. 7.

FIG. 9a illustrates an electronic device in cross-section along the power supply line.

FIG. 9b illustrates the electronic device in cross-section transversely to the power supply line.

FIG. 10a illustrates a pneumatic device in cross-section along the power supply line.

FIG. 10b illustrates the pneumatic device in cross-section transversely to the power supply line.

FIG. 11 illustrates the mechanical fastening of a power supply device or a pneumatic device in cross-section transversely to the power supply line,

FIG. 12 illustrates the air/vacuum supply through a deflecting device.

FIG. 13 illustrates a workpiece receptacle.

FIGS. 14 to 16 each illustrate an embodiment of a deflecting device for a workpiece receptacle.

FIG. 17 illustrates a belt conveyor with a deflecting device in the form of a carriage.

FIGS. 18a, 18b, 18c and 18d illustrate a toothed belt with contact pins in side view, perspective view, front view or in detail.

FIG. 19a illustrates a deflecting device with a groove in the toothed structure.

FIG. 19b is a perspective view of the deflecting device from FIG. 19a with the right toothed structure omitted.

FIG. 19c is a side view of FIG. 19b.

FIGS. 19d and 19e illustrate details of FIGS. 19a to 19c.

FIG. 20 shows a section of a power supply line.

FIG. 21a illustrates a power supply line.

FIG. 21b illustrates the power supply line from FIG. 21a with conveyor belt.

FIG. 22a illustrates a section of a power supply line.

FIG. 22b illustrates the section from FIG. 22a with conveyor belt.

FIG. 23 illustrates a cross-section through a deflecting roll 3.

FIG. 24 shows the upper half of the cross-section from FIG. 23 without pneumatic elements but with elements for supplying electrical energy and/or signals.

FIG. 25 shows an embodiment of a valve device 46 in cross-section.

### DETAILED DESCRIPTION OF INDIVIDUAL EMBODIMENTS

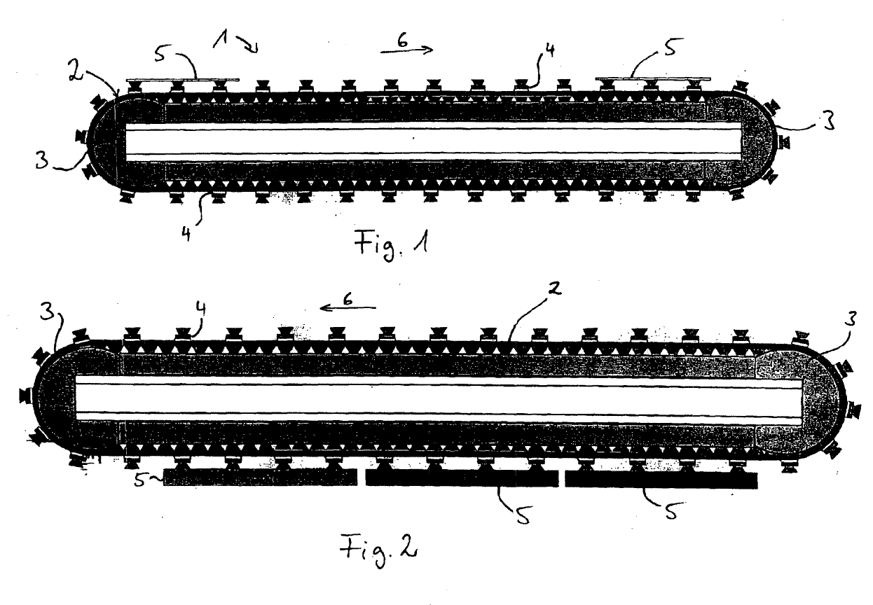

It should, of course, be understood that the description and drawings herein are merely illustrative and that various modifications and changes can be made in the structures disclosed without departing from the present disclosure. Referring now to the drawings, wherein like numerals refer to like parts throughout the several views, the operating mode of the belt conveyor according to the invention is illustrated schematically in FIGS. 1 to 6.

The belt conveyor 1 shown as an example in FIG. 1 comprises a continuous conveyor belt 2 which runs between deflecting devices 3 and has workpiece receptacles 4. The workpiece receptacles 4 can receive workpieces 5 and transport them along the conveying direction 6.

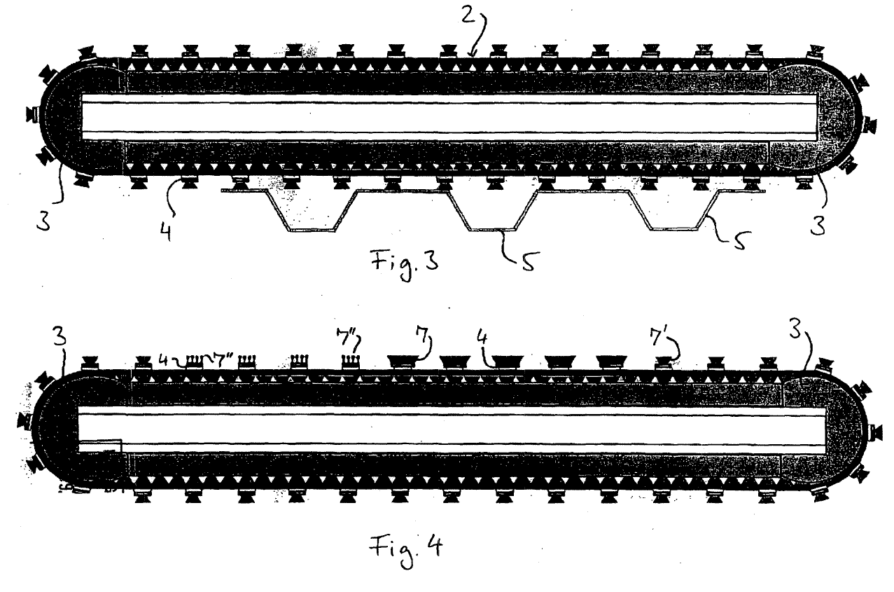

The transport can take place in a lying manner as shown in FIG. 1 or in a suspended manner as shown in FIG. 2. Various workpieces 5 can be transported, for example, electronic circuit boards, metal panels, glass panels, window panes, automobile parts etc. The workpieces 5 need not be flat but can be arbitrarily shaped as illustrated in FIG. 3.

The workpiece receptacles 4 are dimensioned and designed depending on the size of the workpiece. For example, for large and heavy workpieces 5, the workpiece receptacles 4 can each have large workpiece contact elements 7 which are shown as suckers, for example, in FIG. 4 and are exposed to a vacuum through the workpiece receptacles in order to hold the workpieces 5 firmly in a suction manner. For delicate and small workpieces 5 the workpiece contact elements 7″ can be configured to be correspondingly small. In addition, it is expedient in this case to provide a plurality of workpiece contact elements 7″ on one workpiece receptacle 4, cf. FIG. 4. Medium-sized workpiece contact elements 7′ are also illustrated in FIG. 4. Expediently, only same-size workpiece contact elements 7, 7′, 7″ are provided on one conveyor belt 2.

Vertical transport of workpieces 5 is also possible with the belt conveyor 1 according to the invention, cf. FIG. 5.

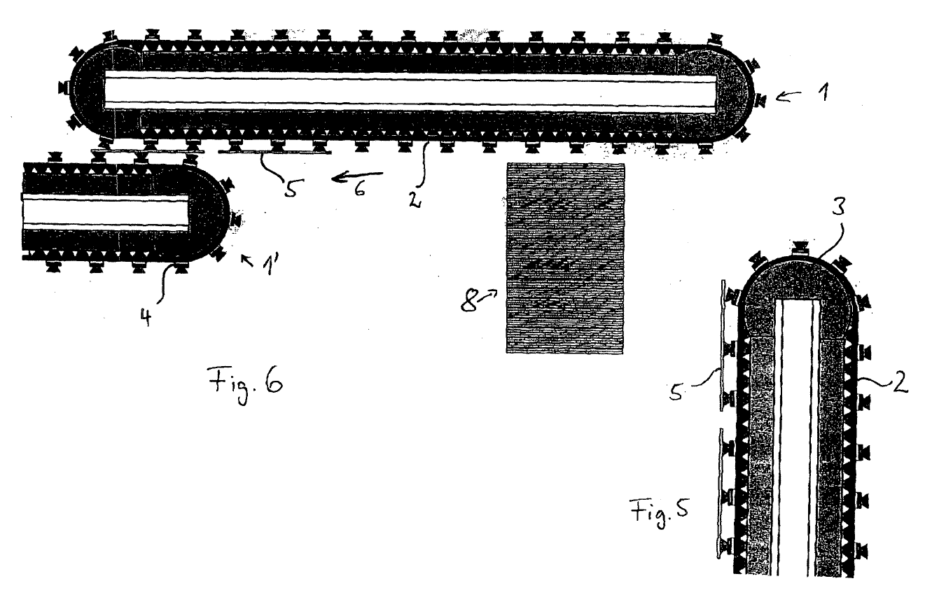

It is furthermore possible to combine a plurality of belt conveyors 1 to form a conveyor system, cf. FIG. 6. For example, a belt conveyor 1 can be used for unstacking workpieces 5, e.g. boards or automobile windscreens, from a stack 8. In this case, a workpiece 5 is removed from the upper end of the stack 8 in each case and fed in the conveying direction 6, e.g. in a suspended manner to another belt conveyor 1 which is used for further distribution of the workpieces 5 for the respective production process.

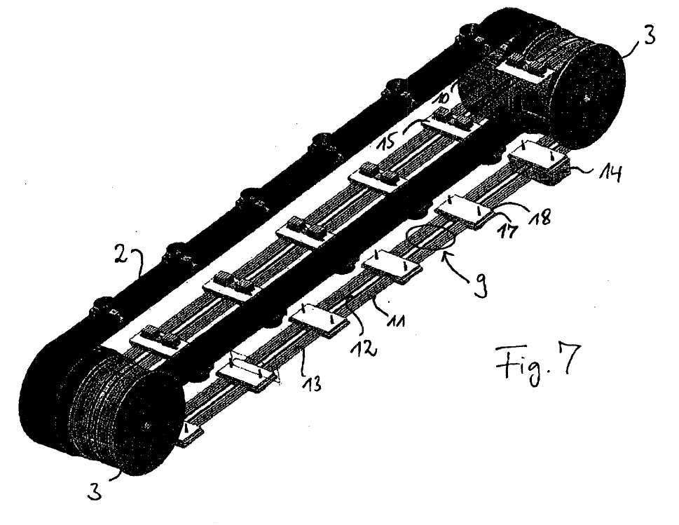

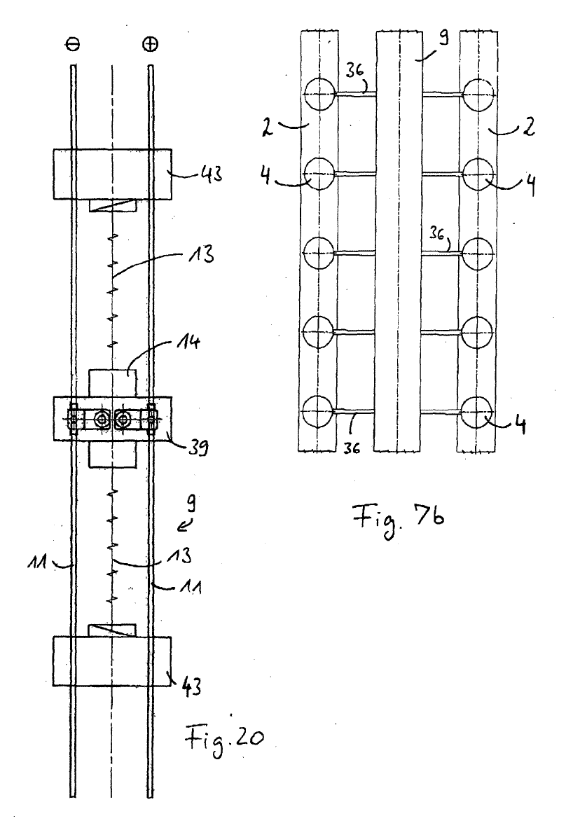

FIG. 7 shows a preferred embodiment of the belt conveyor 1 with a conveyor belt 2 and a power supply line 9 separated from this.

In this embodiment, the conveyor belt 2 runs, for example, around two deflecting devices 3, which are designed here as deflection rolls. The conveyor belt 2 is configured as a toothed belt. The teeth of the toothed belt engage in corresponding grooves 10 on the outer circumference of the deflection rolls forming the deflection device 3. The conveyor belt 2 is thus driven in the conveying direction 6 by the rotational drive of the deflection rolls via the toothed structure.

In this case, the conveyor belt 2 is merely used to absorb forces and transmit forces for carrying or transporting the workpieces 5 and the workpiece receptacles 4. It is correspondingly thick and stably dimensioned. The power supply to the workpiece receptacles 4 is provided by the synchronously running power supply line 9. This runs purely as an example in FIG. 7 adjacently to the conveyor belt 2 over the same deflecting devices 3 but can also be disposed under the conveyor belt 2 or otherwise and can be designed with a shorter or longer circumference as long as it moves synchronously.

The power supply line 9 comprises one or more line elements 11, 12, 13 which are disposed adjacent to one another here but can also be arranged above one another and bears electronic devices 14 and pneumatic devices 15.

The line elements 11, 12 of the power supply line 9 are expediently continuous whilst the line elements 13 are not continuous.

The continuous line elements 11 are here configured, for example, as core cables, i.e. as wire cables or strand cables or steel wires or the like. The power supply to the line elements 11 is effected in this case at least one deflection roll. In this case, for example, the line elements 11 conducting electrical energy can act in or on the deflection roll, for example, via contact pins or sliding contacts. To this end, annular grooves or contact sockets made of conductive material can be formed on the deflection roll so that an electrical contact is made to the sliding contacts or contact pins of the line element 11. Thus, the line element can be acted upon, for example, by a supply voltage and/or by electrical signals, the connection to an external stationary power supply or an external stationary control computer being made, for example, via sliding contacts of the deflection roll shaft in a known manner.

Preferably at least two line elements 11 are used in order to implement a two-wire bus, e.g. according to the ASi standard, in the power supply line 9. Both a supply voltage and also data signals can be transmitted free from interference via the two-wire bus. The supply voltage and the data signals are tapped by electronic devices 14 of which only one is shown in FIG. 7 but preferably a plurality are provided. The electronic devices 14 are therefore preferably individually addressable and controllable and can optionally return signals to the control computer.

The continuous line element 12 is here, for example, designed as an air duct and is additionally expediently designed to be double, i.e. as an internally hollow continuous pipeline e.g. made of plastic or the like. The air duct connects the pneumatic devices 15 to one another and can preferably be acted upon with compressed air or optionally with vacuum. The pneumatic devices 15 relay the vacuum or the compressed air via supply lines preferably in a controlled manner to the workpiece receptacles 4. For simplicity, the supply lines 36 are not shown in FIG. 7 but are illustrated in FIG. 7b and specifically for another embodiment in which the power supply line 9 feeds two adjacent conveyor belts 2. Expediently in this case, each pneumatic device 15 is assigned to precisely one workpiece receptacle 4 and can be located adjacent to this on the power supply line 9. In the workpiece receptacles 4 a vacuum can be produced by means of a Venturi nozzle or the like from the compressed air, by which means of the workpieces 4 are held.

The line elements 13 between the continuous here edge-side line elements 11, 12 are not continuous here. They are used for signal transmission and/or power supply between the electronic devices 14 and the pneumatic devices 15. In the embodiment shown, an electronic device 14 expediently takes over the control of a plurality of pneumatic devices 15, 15′, 15″, 15″′, cf. FIG. 8. For this purpose, line elements 13 extend between the electronic device 14 and the first pneumatic device 15, line elements 13′ extend between the electronic device and the second pneumatic device 15′, line elements 13″ extend between the electronic device 16 and the pneumatic device 15″ and line elements 13″′ extend between the electronic device 14 and the pneumatic device 15″′. A number of 3, 4, 5, 6 or 7 pneumatic devices 15 which are assigned to an electronic device 14 and individually controlled by said device via the line elements 13 is expedient. The line elements 13 running between an electronic device and a pneumatic device 15 are appropriately two-wire lines as shown.

The fastening of the electronic devices 14 and the pneumatic devices 15 to the power supply line 9 is illustrated in detail in FIG. 9 or 10.

The electronic device 14, shown in FIG. 9a in section along the line element 11, is clamped to the power supply line 9 by means of two plates 16, 17 running transversely to the power supply line 9 and enclosing this between them. For this purpose, the plates 16, 17 are screwed by means of screws 19, as shown in FIG. 9b or fastened to one another in another manner. Suitable recesses can be provided for the line elements 11, 12, 13 so that these are not squashed. The line elements 11, 13 are each connected electrically to connections of the electronic device 14, for example, by means of terminals with contact pins to the line elements. In addition, the line elements 11 used to supply energy and signals externally are electrically connected to contact elements 20, for example, sliding contacts or contact pins, in particular spring-pre-tensioned copper or carbon pins. The contact elements 20 come into electrical contact with corresponding counter-contact elements on the deflection rolls, e.g. the aforesaid conductive annular grooves and/or contact sockets for contact elements configured as contact pins. The engagement of contact pins in corresponding sockets ensures a reliable and sufficiently interference-free electrical connection, especially as at all times a contact pin or sliding contact always maintains the electrical connection between the line element 11 and the deflection roll.

The pneumatic devices 15 are also fastened to the power supply line 9 by means of two plates 16, 17, cf. FIGS. 10a, b. These have a controllable valve 21 which is connected to the line elements 13 via a line 22 or a plurality of lines 22. The vacuum supply to the line elements 12 is effected, as described hereinafter, by contact elements 23, for example in the form of check valves.

As shown in FIG. 11, the plates 16, 17 can be provided with lateral guide and/or sliding surfaces 24. These can be guided in stationary guide grooves to prevent sagging of the power supply line 9.

The vacuum supply is effected by at least one of the deflecting devices 3. For this purpose, the deflecting device 3 has radially extending ducts 25, cf. FIG. 12. In the ducts 25 the central compressed air or vacuum supply is effected through the shaft 26. Now, if one of the revolving pneumatic devices 15 comes into engagement with its contact element 23 with the radially outer end of a duct 25, cf. FIG. 12, a connection is made between the duct 25 and the line element 12 as a result of the contact element 23. The line element 25 is thus supplied with compressed air or vacuum from the shaft 26. Supply takes place as long as the contact elements 23 contacts the radially outer end of the channel 25, in the example shown therefore for half a revolution. The contact element is then released since the pneumatic device 15 moves away from the defecting device 3. Expediently, the contact elements 23 are spaced apart along the power supply line 9 such that at the revolving power supply line 9 at all times at least one contact element 23 makes the connection between the line element 12, e.g. a hollow continuous pipeline and the shaft 26. Thus, a sufficient pressure or a sufficient vacuum is present in the line element 12 at all times.

During operation the shaft 26 of at least one deflecting device 3 is continuously supplied with compressed air (or vacuum). The compressed air (or the vacuum) is also available at all times via the ducts 25 in the line element 12. The pneumatic devices 15, optionally controlled by the electronic devices 16 and ultimately the control computer not shown, produce a vacuum from the compressed air by means of Venturi nozzles 29 (FIG. 13) or the like or relay the vacuum in a controlled manner to the workpiece receptacles 4. Appropriately, only those workpiece receptacles which are transporting a workpiece are acted upon by vacuum. If no workpiece 5 is present at a workpiece receptacle 4, a valve in the pneumatic device can be closed to save compressed air/vacuum. For this purpose, it can be provided in particular that a sensor is disposed on the workpiece receptacle 4 or the pneumatic device 15, which determines a loss of pressure, from which it can be concluded that no workpiece 5 is held by this receptacle 4 so that the air supply to this workpiece receptacle 4 can be interrupted. Alternatively to this, other detection means can be provided, for example, optical sensors.

As described previously, vacuum can be generated in the pneumatic device 15 or, as shown in FIG. 13, in the workpiece receptacles 4. In this case, compressed air passes through an inlet 27, optionally via a controllable valve 28, to a Venturi nozzle 29 which generates a vacuum from the compressed air for the suction bell (workpiece contact element 7) and blows out the compressed air via an outlet 30.

Instead of the air-based workpiece receptacles 4 with the line element 12 and the pneumatic devices 15, mechanical grippers or electromagnets can also be used. Thus, the air/vacuum feed in the deflecting device by means of the ducts 25 is omitted. The pneumatic device 15 and the line element 12 in the form of a pipeline can then also be dispensed with. A considerable design simplification is achieved.

In order to receive a workpiece 5, it is appropriate if the workpiece receptacle 4 is deflected in the direction of the workpiece 5. For this purpose, a deflecting device is expediently provided. This can be designed as shown in FIGS. 14 to 17.

In FIG. 14 the deflecting device is integrated in the deflection roll 31. Thus, the deflection roll 31 can have a cam 32. The cam 32 thereby presses from inside onto the conveyor belt 2. To this end, the deflection roll 31 can run with the conveyor belt 2, in which case the cam 32 is then synchronised with the workpiece receptacle 4 in such a manner that each workpiece receptacle 4 is deflected in the direction of a workpiece 4 when it passes the deflection roll 31.

Alternatively to this, the cam 32 can be designed to be controlled. For this purpose, a pneumatic cylinder can be provided in the deflection roll 31. It is also possible to provide a pneumatic cylinder which surrounds the deflection roll 31 and enlarges its diameter when it is acted upon by compressed air.

In the embodiment shown in FIG. 15, the entire deflection roll 31 is deflected. The rest position is shown by the dashed line whilst the deflected position is shown by the continuous line. The deflection can be effected, for example, by a pneumatic cylinder.

In FIG. 16 the deflection is effected by thickening the conveyor belt 2 in the inward direction at the location of the workpiece receptacle 4. Due to the thickening 33 the workpiece receptacle 4 is deflected outwards when the workpiece receptacle 4 passes by an arbitrary deflection roll. The thickening is appropriately configured at a location of a tooth if the conveyor belt 2 is a toothed belt. The further advantage is then obtained that the fastening device for the workpiece receptacle 4 can then be configured to be thick and therefore resistant and long-lived since the associated thickening is desirable at this location.

Due to the embodiment according to FIGS. 14, 15 and 16, a stroke between 5 mm and 25 mm is appropriately achieved, preferably of about 10 mm. By this means, workpieces 4 can be simply received. A mechanical lifting device is not necessary in the workpiece receptacle so that the design is appreciably simplified. In particular, during unstacking, cf. FIG. 6, the belt conveyor according to the invention is particularly advantageous. The workpiece 4 can be released from the workpiece receptacle 4 in a simple manner whereby the vacuum is switched off, a gripper opens or an electromagnet is disconnected or optionally its polarity is reversed.

In the belt conveyor shown in FIG. 17, two deflecting device 3 are provided between which the conveyor belt revolves. In addition, a carriage 34 which can be deflected vertically by a pneumatic cylinder or the like is provided, here comprising two rollers 31. The carriage 34 can be deflected downwards in order to deflect workpiece receptacles 4 in the direction of workpieces 5.

The deflection of the deflecting device can be effected by synchronisation of stationary deflecting devices, e.g. the fixed cam 32 or the thickening 33. It is also possible to specifically control the deflection. The control computer, not shown, can be used for this purpose. For this purpose it is advantageous if light curtains attached in a fixed position or other optical, mechanical, magnetic or position sensors are provided which can detect the position of the workpiece receptacles 4. In the simplest case, merely one position sensor is provided; this is sufficient since the spacing and the number of workpiece receptacle 4 is fixedly predefined and does not alter during operation. When a workpiece receptacle 4 moves past the position sensor, a corresponding signal is generated from which the control computer can determine the position of all the workpiece receptacles 4 at this time. The speed of the conveyor belt 2 can also be measured by calculating the time interval between two successive signals and relating this to the known spacing between the workpiece receptacles 4. Thus, the vertical deflection of a workpiece receptacle 4 in the direction of a workpiece 5 can be precisely controlled.

Optionally, the power supply unit 9 can be combined with the conveyor belt 2 to form a single mechanical unit. In this case, the line elements 11, 12, 13 run in corresponding channels in the conveyor belt 2. The electrical and pneumatic contact can take place in the same manner for which, for example, mechanical contact elements 20 in the form of electrical contact pins can also be provided, cf. FIG. 18. The contact pins can preferably be screwed to the toothed belt, cf. FIG. 18d. The same fastening can be provided at the plates 17, 18 of the electronic device 14. The line elements 11, 12, 13 can also be connected to a flat carrier so that the power supply line 9 forms a belt.

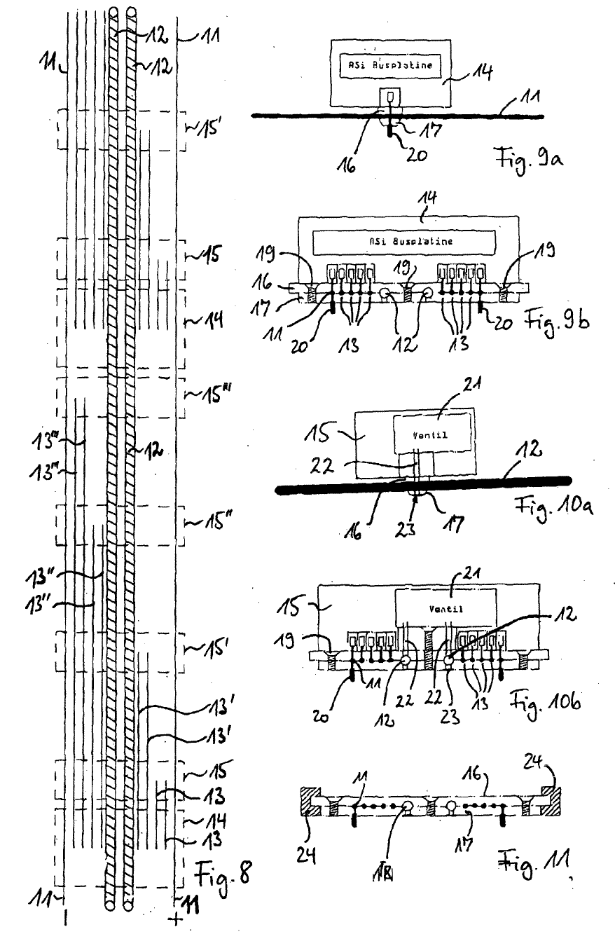

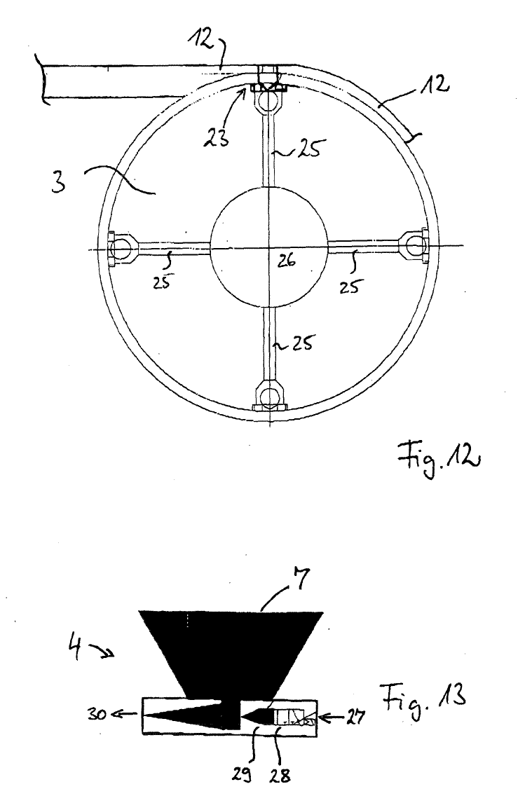

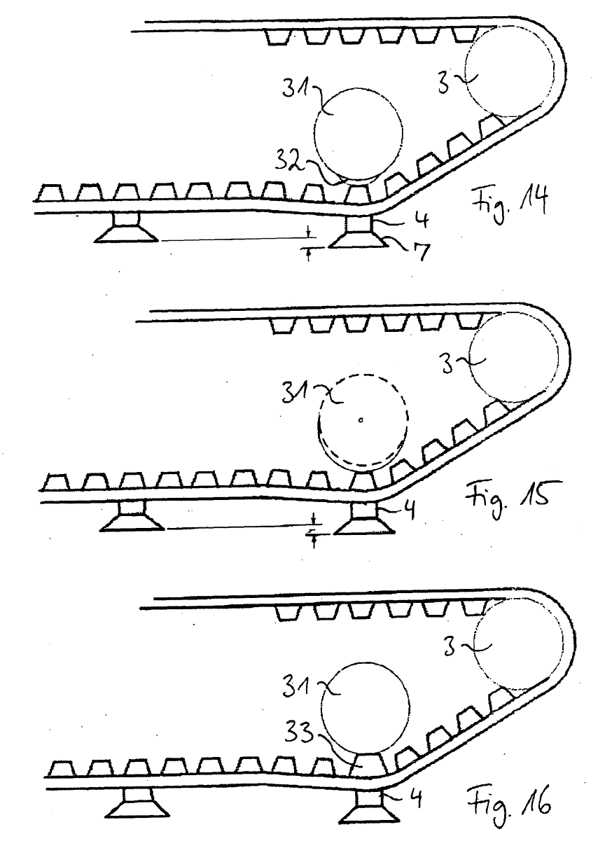

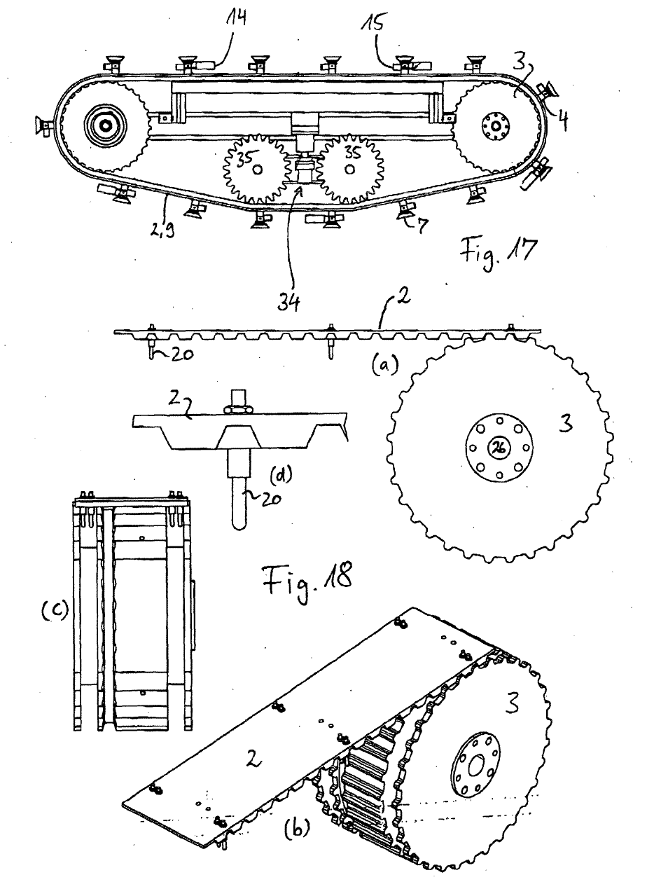

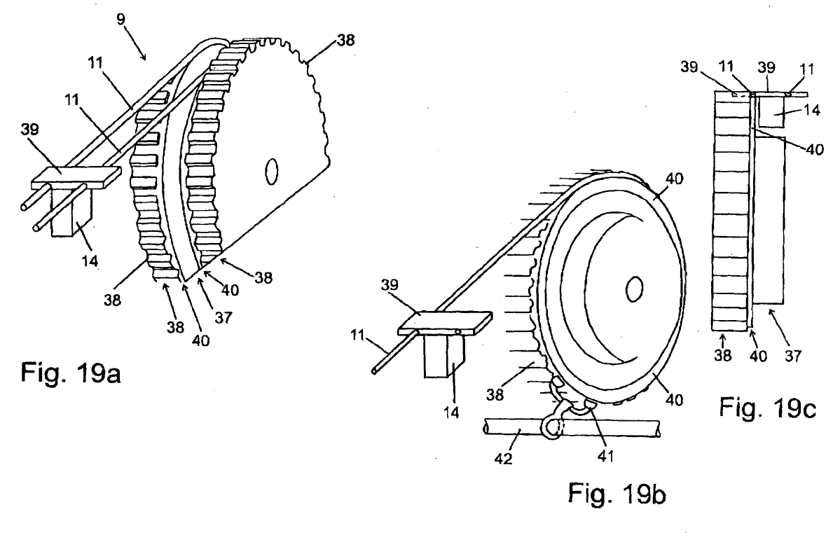

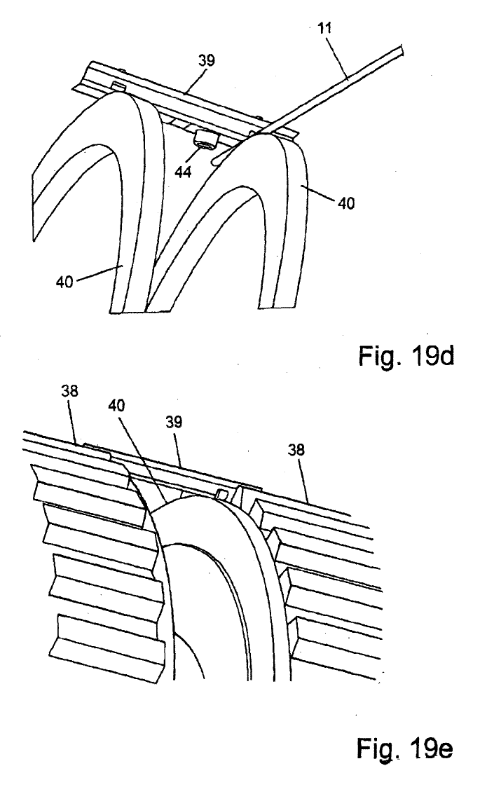

In the embodiment of FIG. 7, the power supply line 9 is disposed adjacently to the conveyor belt 2. Alternatively to this, the power supply line 9 can also be disposed under the conveyor belt 2, cf. FIGS. 19 to 24.

For this purpose, the deflecting device 3 is preferably provided with a central groove 37 between the toothed structure 38, cf. FIG. 19a. The groove 37 is dimensioned so as to fit the electronic devices 14 and, if provided, also pneumatic devices 15 which are fastened internally to a continuous loop of line elements 11 in the form of steel cables or the like by means of supporting plates 39, wherein the supporting plates 39 can be constructed in one piece or, as shown in FIGS. 9 to 11 also from two plates 17, 18 or a plurality of individual parts.

The line elements 9 serve in this case to supply the electronic devices 14 with electrical energy and/or electrical control signals and for this purpose form, for example, a two-wire bus. Each of the line elements 9 in this case rolls on an associated sliding ring 40, e.g. made of brass or the like. The sliding rings 40 are supplied with energy and/or signals by means of sliding contact devices 42 which make the electrical connection to an external line 41, cf. FIG. 19b.

The supporting plate 39 is expediently configured in such a manner that it fits between two successive teeth of the toothed structure 38 as illustrated at the top in FIG. 19c. Said plate is preferably tooth-shaped itself in such a manner that it fits complementarily in the intermediate space between two teeth of the toothed structure 38. Accordingly, it is expedient if the diameter of the sliding rings 40 corresponds to the diameter of the toothed structure 38 between the teeth, in any case is smaller than the diameter of the toothed structure 38 at the teeth.

FIG. 19d illustrates the two sliding rings 40 with the complementarily tooth-shaped supporting plate 39 which has a fastening element 44 for the electronic device 14 and one of the two line elements 11. FIG. 19e additionally shows the toothed structure 38 on both sides of the groove 37, wherein however the line element 11 is not shown.

A section of the line element 9 illustrated in FIG. 19 is shown in detail in FIG. 20. The preferably tooth-shaped supporting plate 39 is fastened to line elements 11, taps current and/or signals from this and bears an electronic device 14 which it thus supplies. The electronic device 14 is connected to further devices 43 via finite line elements 13, as illustrated in FIG. 8. The further devices 43 can comprise actuators or sensors or pneumatic devices 15 or further electronic devices 14 or the like.

FIG. 21a illustrates a power supply line 9 with two parallel line elements 11 revolving between two deflecting devices 3, but for simplicity only in the upper region between the deflecting devices 3. The deflecting devices 3 each have a toothed structure 38. The line elements 11 bear electronic devices 14 and pneumatic devices 45. FIG. 21b additionally shows the conveyor belt 2 in the lower region between the deflecting devices 3. The conveyor belt 2 is also toothed and is driven by the deflecting devices 3.

The section 46 from FIG. 21b, shown enlarged in FIG. 21c, illustrates the electronic devices 14 on the line elements 11 e.g. in the form of steel cables as well as pneumatic devices 45 which are supplied with compressed air or vacuum, as described hereinafter. Each pneumatic device 45 is appropriately assigned one, optionally also a plurality of valve devices 46 and connected thereto via lines for compressed air or vacuum, not shown, in order to provide a vacuum for the workpiece receptacle 4 at the valve device 46, e.g. via a Venturi nozzle. The valve device 46 can be actuated (on/off) by an associated electronic device which can also be cabled to the valve device 46, which however is not shown since the valve device 46 is preferably not controlled but the pneumatic device 45 switches the vacuum or the compressed air to the valve device 46.

For supplying with compressed air or vacuum, the pneumatic devices 45 are coupled to line elements 12, e.g. hoses, cf. FIG. 22a. The coupling can take place as shown in FIGS. 10 and 11. Further line elements 30 can also be provided so that a power supply line 9 as in FIGS. 7, 8 with the coupling as in FIGS. 9 to 11 is formed. FIG. 22b shows the embodiment from FIG. 22a with conveyor belt 2 resting thereon, which bears the valve devices 46 and workpiece receptacles 4. The conveyor belt 2 and the power supply line 9 can be intercoupled via coupling elements 47.

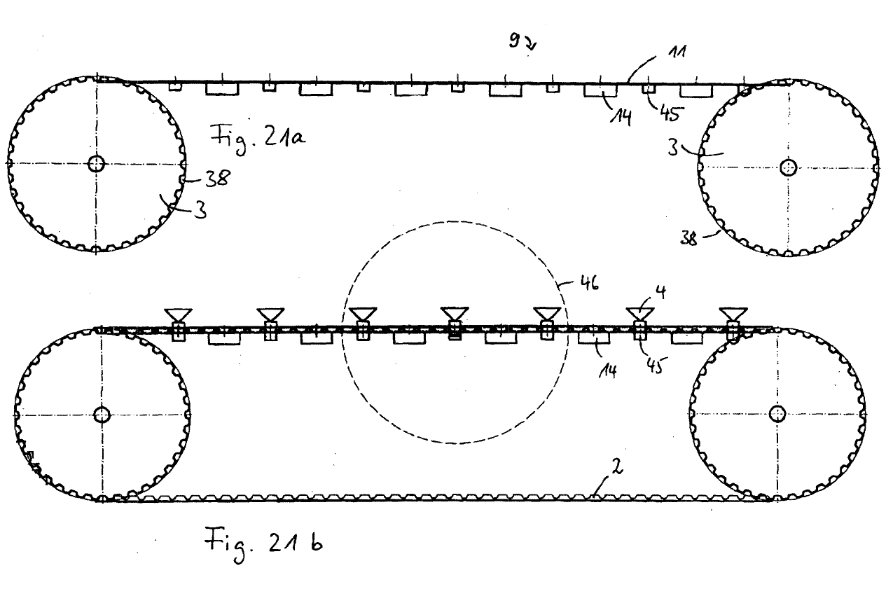

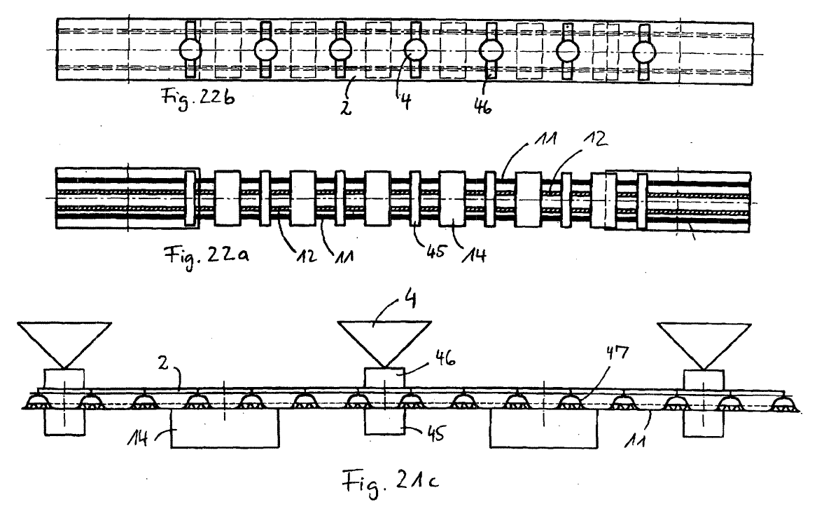

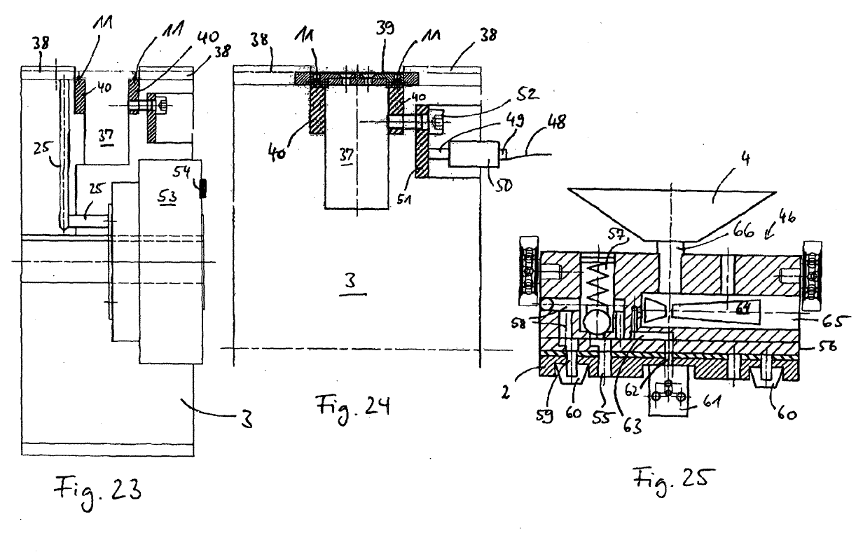

The coupling-in of electrical energy as well as compressed air or vacuum can be implemented in various ways, wherein different embodiments for compressed air/vacuum coupling-in can be combined with different embodiment for coupling in the electrical energy, that is, independently of one another and shown here together only as an example. Possible implementations are described with reference to FIGS. 23, 24 and 25. FIG. 23 shows a cross-section through a deflection roll 3. This can comprise the deflection roll 3 shown in FIG. 12 or another one. FIG. 24 shows the upper half of the cross-section of FIG. 23 without pneumatic elements but with elements for supplying electrical energy and/or signals. FIG. 25 shows a possible embodiment of a valve device 46 in cross-section.

The electrical energy and/or electrical signals which are supplied via a line 48 from a power supply or a controller, cf. FIG. 23, is initially fed in via a contact 49, e.g. a carbon pin which is pressed against an external sliding ring 51 by means of a tensioning device 50. The sliding ring 51 is connected in an electrically conducting manner to the sliding ring 40, e.g. via a screw connection 52. There the line element 11 taps current and/or signals in sliding contact. This is illustrated in FIG. 24 only for the right sliding ring 40. The left sliding ring 40 can be connected similarly to another line.

The compressed air or vacuum can be supplied as illustrated in FIG. 23. For this purpose, a reservoir 53 is coupled, for example, via a feed 54 to an external compressed air hose. The feed 54 can comprise a rotating coupling. The reservoir 53 can also be coupled to the external compressed air hose in a different manner. The compressed air is fed via duct 25 to the external compressed air hose and preferably opens into the toothed structure 38 and expediently between two teeth. A return valve not shown can be provided at the orifice so that no compressed air escapes when the orifice is exposed, cf. the left half in FIG. 12 whilst compressed air can be passed on when the orifice couples, cf. the right half in FIG. 12.

The orifice can couple with a counterpart in a pneumatic device 45 or with a counterpart in the conveyor belt 2.

The coupling to the pneumatic device 45 corresponds to that in FIG. 12 for the embodiments in which conveyor belt 2 and power supply line 9 are disposed adjacent to one another. For this purpose the pneumatic devices 45 should be configured to be sufficiently wide so that they overlap with the duct 25 which no longer runs centrally in the deflection roll 3 but laterally of the groove 37. In the area of the feed the conveyor belt 2 can additionally press the pneumatic devices 45 onto the orifices so as to ensure a loss-free feed of compressed air into the pipes 12. In this case, the pneumatic devices 45 expediently have the form of a tooth of the conveyor belt 2 at which a corresponding tooth is missing at the respective locations.

The coupling with the counterpart in the conveyor belt 2 is illustrated in FIG. 25 which shows a cross-section at a location with an exemplary valve device 46. An opening 55 in the conveyor belt 2 and an intermediate plate 56 used for mounting the valve device 46 align with the orifice of the duct 25. Compressed air is guided from the duct 25 through the aperture 55 to a return valve 57. The return valve 57 opens when it is acted upon with compressed air from the opening 55. The compressed air is then passed into the duct 58. There it passes via a further aperture 59 into an air duct 60 which can be a separate air duct or the line element 12. Compressed air from the air duct 60 passes via an in particular switchable valve 61, which is shown here as fastened to the conveyor belt 2 but can also be disposed in pneumatic devices 45, via a further aperture 62 and a duct 63 to a vacuum generator 64, e.g. to a Venturi nozzle. The compressed air is blown out via an outlet 65. Vacuum is passed via a duct 66 to the workpiece receptacle 4.

Further embodiments can be deduced from the foregoing description, the figures and the following claims. The individual aspects are each of independent inventive importance and can be combined with one another unless expressly excluded. Further embodiments of the invention are in particular:
1. A belt conveyor (1) comprising a continuous conveyor belt (2) running between deflection rolls (3, 31), to which a workpiece receptacle (4) is attached, characterised in that a synchronously revolving continuous power supply line (9) is provided.
2. The belt conveyor according to embodiment 1, characterised in that the power supply line (9) comprises a continuous line element (11, 12).
3. The belt conveyor according to embodiment 2, characterised in that the line element (12) is a channel for compressed air, vacuum, a liquid or a fluid.
4. The belt conveyor according to embodiment 2 or 3, characterised in that the line element (11) is electrically conductive.
5. The belt conveyor according to any one of embodiments 1 to 4, characterised in that the power supply (9) carries a pneumatic device (15) and/or an electronic device (14) which take compressed air or vacuum or electrical energy and/or electrical signals from the power supply line (9).
6. The belt conveyor according to any one of embodiments 1 to 5, characterised in that the power supply line (9) is connected via a deflection roll (3) to an external power and/or signal source.
7. The belt conveyor according to any one of embodiments 1 to 6, characterised in that the pneumatic devices (15) each supply compressed air or vacuum to a workpiece receptacle (4) in a controlled manner.
8. The belt conveyor according to any one of embodiments 1 to 7, characterised in that the power supply line (9) is disposed adjacent to or below the conveyor belt (2).
9. The belt conveyor according to embodiment 8, characterised in that the deflection rolls (3, 31) have a circumferential groove (37) on the outer circumference.
10. The belt conveyor according to embodiment 9, characterised in that a slip ring (40) is provided on both sides of the groove (37) for supplying the power supply line (9) with electrical energy and/or electrical signals.
11. A power supply line (9) for a belt conveyor (1), in particular according to one of embodiments 1 to 10, characterised in that it has a continuous line element (11, 12) for transporting energy.
12. The power supply line (9) according to embodiment 11, characterised in that it has a continuous line element (13) extending between two sections for transporting energy and/or information between the sections.
13. The power supply line according to embodiment 11 or 12, characterised in that it can be coupled to workpiece receptacles (4) of a synchronously drivable conveyor belt (2) in order to supply this with energy.
14. A deflection roll (3) for a belt conveyor, in particular according to one of embodiments 1 to 10, characterised in that it has a section for driving a power supply line (9) and for feeding energy into a power supply line (9), in particular according to one of embodiments 8 to 10.
15. The deflection roll (3) according to embodiments 14, characterised in that this has a circumferential groove (37) on the outer circumference.
16. The deflection roll (31) for a belt conveyor (1), in particular according to one of embodiments 1 to 10, characterised in that the deflection roll (31) has a cam (32).
17. A pneumatic device (15) for a belt conveyor (1), in particular according to one of embodiments 1 to 10, characterised in that this can be fastened to a power supply line (9), in particular according to one of embodiments 8 to 10, and has means for taking energy from the power supply line (9) and can be coupled to a workpiece receptacle (4).
18. An electronic device (14) for a belt conveyor (1), in particular according to one of embodiments 1 to 10, characterised in that this can be fastened to a power supply line (9), in particular according to one of embodiments 8 to 10, and has means for taking energy from the power supply line (9) and can be coupled to a pneumatic device (15) and/or to a workpiece receptacle (4).
19. The electronic device according to embodiment 18, characterised in that this is configured for controlling a pneumatic device (15) and/or a workpiece receptacle (4).
20. The electronic device according to embodiment 18 or 19, characterised in that this is configured for taking control information from the power supply line (9).
21. The belt conveyor (1), in particular according to one of embodiments 1 to 10, comprising a continuous conveyor belt (2) running between deflection rolls (3, 31), to which a workpiece receptacle (4) is attached, characterised in that the conveyor belt (2) cooperating with a roller (31) forms a deflecting device for deflection of the workpiece receptacle (4) in the direction of a workpiece (5).
22. The belt conveyor according to embodiment 21, characterised in that on the side of the conveyor belt (2) running on the deflection rolls (3, 31) a local thickening (33) is provided at the location of the workpiece receptacle (4).
23. The belt conveyor according to embodiment 21 or 22, characterised in that a deflection roller (31) has a cam (32).
24. The belt conveyor according to any one of embodiments 21 to 23, characterised in that a deflecting device is provided for deflecting a deflection roll (3, 31) in the direction of a workpiece (4) to be received.
25. The belt conveyor (1), in particular according to one of embodiments 1 to 10, comprising a continuous conveyor belt (2) running between deflection rolls (3, 31), to which a workpiece receptacle (4) is attached, and which has teeth on a side running on the deflection rolls (3) which engage with teeth on a driving deflection roll (3), characterised in that at the position of the workpiece receptacle (4) a tooth is omitted and a holding device is provided for the workpiece receptacle (4).
26. The belt conveyor according to embodiment 25, characterised in that the conveyor belt (2) has a channel for supplying the workpiece receptacle (4) with pneumatic energy and the holding device is clamped on the conveyor belt (2) which is tightly connected to the channel and the workpiece receptacle (4).
27. The belt conveyor (1), in particular according to one of embodiments 1 to 10, comprising a continuous conveyor belt (2) running between deflection rolls (3, 31), to which a workpiece receptacle (4) is attached, characterised in that along the workpiece conveying section, a fixed device is provided for interaction with the workpiece receptacle (4) revolving with the conveyor belt (2) and/or with a pneumatic or electronic device revolving with the optionally provided power supply line (9).
28. The belt conveyor according to embodiment 27, characterised in that the workpiece receptacle (4) comprises a guide and/or sliding surface and the device has a force-receiving fixed guide extending along the workpiece conveying section on which the workpiece receptacle (4) is supported.
29. The belt conveyor according to embodiment 27 or 28, characterised in that the device has a fixed actuator along the workpiece conveying section and the workpiece receptacle, the pneumatic device or the electronic device has an actuating counterpart.
30. The belt conveyor (1), in particular according to one of embodiments 1 to 10, comprising a continuous conveyor belt (2) running between deflection rolls (3, 31), to which a workpiece receptacle (4) is attached, characterised in that a controllable valve (28) is provided in the workpiece receptacle (28).
31. The belt conveyor (1), in particular according to one of embodiments 1 to 10, comprising a continuous conveyor belt (2) running between deflection rolls (3, 31), to which a workpiece receptacle (4) with a sucker (7) for receiving and holding a workpiece (5) with vacuum is fastened, characterised in that the sucker (5) is pivotally fastened to the workpiece receptacle (4).
32. A conveyor belt (2) for a belt conveyor (1) according to one of the preceding embodiments,
33. The conveyor belt according to embodiment 32, characterised in that a local thickening (33) is provided on one side of the conveyor belt (2) for running on a roller (3, 31).
34. The conveyor belt according to embodiment 32 or 33, characterised in that a workpiece receptacle (4) can be fastened to the conveyor belt (2) and the conveyor belt (2) has teeth on one side for engaging with teeth on a driving deflection roll (3) of the belt conveyor, wherein at the position of the workpiece receptacle a tooth is omitted and a holding device is provided for the workpiece receptacle.
35. A workpiece receptacle (4) for a belt conveyor (1) according to any one of embodiments 1 to 10.
36. The workpiece receptacle according to embodiment 35, characterised in that the workpiece receptacle (4) has a controllable valve (28).
37. The workpiece receptacle according to embodiment 35 or 36, characterised in that the workpiece receptacle (4) can be fastened to a conveyor belt (2) and has a supporting element for supporting on a force-absorbing fixed guide of the belt conveyor along the workpiece conveying section.
38. The workpiece receptacle according to any one of embodiments 35 to 37, characterised in that the workpiece receptacle has an actuator counterpart which can be actuated by a fixed actuator of the belt conveyor (1) along the workpiece conveying section.
39. The workpiece receptacle according to any one of embodiments 35 to 38, characterised in that the workpiece receptacle (4) has a sucker (7) for receiving and holding a workpiece (5) by means of vacuum and the sucker (7) is fastened pivotally on the workpiece receptacle (4).

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A belt conveyor comprising a continuous conveyor belt running between deflection rolls, to which a workpiece receptacle is attached, wherein a synchronously revolving continuous power supply line is provided, the power supply line being formed separately from the conveyor belt.

2. The belt conveyor according to claim 1, wherein the power supply line comprises a continuous line element.

3. The belt conveyor according to claim 2, wherein the line element is a channel for compressed air, vacuum, a liquid or a fluid.

4. The belt conveyor according to claim 2, wherein the line element is electrically conductive.

5. The belt conveyor according to claim 2, wherein the power supply carries at least one of a pneumatic device which takes compressed air or vacuum from the power supply line and an electronic device which takes electrical energy and/or electrical signals from the power supply line.

6. The belt conveyor according to of claim 5, wherein the power supply line is connected via one of the deflection rolls to at least one of an external power and signal source.

7. The belt conveyor according to any one of claim 5, wherein the pneumatic device supplies compressed air or vacuum to a workpiece receptacle in a controlled manner.

8. The belt conveyor according to claim 1, wherein the power supply line is disposed adjacent to or below the conveyor belt.

9. The belt conveyor according to claim 8, wherein the deflection rolls have a circumferential groove on the outer circumference.

10. The belt conveyor according to claim 9, wherein a slip ring is provided on both sides of the groove for supplying the power supply line with electrical energy and/or electrical signals.

11. A power supply line for a belt conveyor comprising at least one continuous line element for transporting energy, the power supply line being free of workpiece receptacles.

12. The power supply line according to claim 11, including a continuous line element extending between two sections for transporting at least one of energy and information between the sections.

13. The power supply line according to claim 11, wherein the at least one continuous line element can be coupled to workpiece receptacles of a synchronously drivable and separately formed conveyor belt in order to supply this with energy.

14. A deflection roll for a belt conveyor comprising a section for driving a conveyor belt with a workpiece receptacle, wherein the deflection roll includes a section for feeding energy into and for driving synchronously with the conveyor belt a power supply line formed separately from the conveyor belt.

15.-39. (canceled)
